(19) United States
(12) Patent Application Publication
(10) Pub. No.: US 2024/0303560 A1
(43) Pub. Date: Sep. 12, 2024

(54) SYSTEMS AND METHODS FOR A SMALL BUSINESS OUTSOURCER

(71) Applicant: WELLS FARGO BANK, N.A., San Francisco, CA (US)

(72) Inventors: Sadie Salim, Mill Valley, CA (US); Rajeswaran Govindan, Livermore, CA (US); Dennis E. Montenegro, Concord, CA (US)

(21) Appl. No.: 17/809,346

(22) Filed: Jun. 28, 2022

(51) Int. Cl. G06Q 10/06; G06Q 20/10

(52) U.S. Cl. CPC G06Q 10/06311; G06Q 10/0637; G06Q 20/102

(57) ABSTRACT

Systems and methods for assisting small businesses to manage variable workflows using machine learning and artificial intelligence to outsource work are disclosed. One disclosed system includes one or more processors and memory with stored instructions which when executed by the one or more processors cause the one or more processors to receive business data from a first business; receive an outsourcing request from the first business; determine, based on the business data, one or more second businesses capable of fulfilling the outsourcing request; determine a selected business from the one or more second businesses; and transmit a message to the selected business.

### FIELD OF TECHNOLOGY

The present disclosure generally relates to artificial intelligence and machine learning, and more particularly to systems and methods for using artificial intelligence and machine learning to manage variable workflows by outsourcing work between small businesses.

### BACKGROUND

Small businesses are at a competitive disadvantage to larger businesses because small businesses often lack resources to maintain infrastructure and a workforce capable of managing variable workflow. Due to lacking sufficient resources, during situations of higher than expected workflow, small businesses may be unable to keep up with customer requests, and may have to turn away work. Larger businesses often have significantly more resources, allowing larger businesses to employ enough workers to manage higher than expected workflow. Thus, there is a need for a system that assists small business owners in managing variable workflows.

### SUMMARY

According to certain embodiments, a method for a small business outsourcer may comprise receiving business data from a first business; receiving an outsourcing request from the first business; determining, based on the business data, one or more second businesses capable of fulfilling the outsourcing request; determining a selected business from the one or more second businesses; and transmitting a message to the selected business.

According to another embodiment, a non-transitory computer readable medium may comprise program code, which when executed by one or more processers, causes the one or more processors to receive business data from a first business; receive an outsourcing request from the first business; determine, based on the business data, one or more second businesses capable of fulfilling the outsourcing request; determine a selected business from the one or more second businesses; and transmit a message to the selected business.

According to another embodiment, a system for a small business outsourcer may comprise one or more processors that perform operations to receive business data from a first business; receive an outsourcing request from the first business; determine, based on the business data, one or more second businesses capable of fulfilling the outsourcing request; determine a selected business from the one or more second businesses; and transmit a message to the selected business.

This illustrative example is mentioned not to limit or define the limits of the present subject matter, but to provide an example to aid understanding thereof. Illustrative examples are discussed in the Detailed Description, and further description is provided there. Advantages offered by various examples may be further understood by examining this specification and/or by practicing one or more examples of the claimed subject matter.

### BRIEF DESCRIPTION OF THE DRAWINGS

A full and enabling disclosure is set forth more particularly in the remainder of the specification. The specification makes reference to the following appended figures.

FIG. 1 illustrates a flow chart for a method of operating a small business outsourcer according to one embodiment.

FIG. 2 illustrates a flow chart for a method of operating a small business outsourcer according to another embodiment.

FIG. 3 illustrates a flow chart for a method of operating a small business outsourcer, according to another embodiment.

FIG. 4 shows an illustrative example of a small business outsourcer system communicating between user devices and data sources.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Embodiment of a Small Business Outsourcer

In one illustrative embodiment of a small business outsourcer, the small business outsourcer comprises an application executed on a computer system for matching small businesses for outsourcing of work to allow small businesses to manage variable workflows. The application receives business data from a first business. For example, the application receives information such as type of business, location of the business, services provided by the business, products sold by the business, material used in the business, tools used by the business, and other information such as hours of operation, cost of services, and other business information. The application includes questionnaires and templates for small business owners to submit information regarding their small businesses. For example, a small business owner of a woodworking shop may enter all of the services that the business provides and the tools owned by the small business. The small business owner may also be prompted to enter the products that the small business owner produces and pricing information related to the small business's products and services.

In some embodiments, the application also uses agents, such as a bot or web crawler, to identify information associated with outsourcing requests from data sources such as a business's website, other business's websites, databases, sensors, social media feeds, and other sources. The agents may use a variety of web scraping techniques, such as HTML parsing and DOM parsing to extract information from websites, and other sources. The agents may be further configured to: establish and activate API calls; screen scrape information by extracting readable information from websites of businesses; implement Natural Language Processing (NLP) to extract information from websites through the websites' HTML code; and process audio/visual sources. For example, where a small business such as a restaurant uploads a picture of the restaurant's menu, the small business outsourcer processes the picture of the menu and determines written contents of the menu, as well as draws inferences regarding what ingredients are used in food on the menu.

In some embodiments, the application includes surveys, questionnaires, and templates that are pre-configured for types of businesses and are connected to data sources. For example, the woodworking shop small business owner chooses a template related to woodworking shops. In such an embodiment, the template includes data sources such as access to a database for local woodworking shops and carpenters, which may be used by the application. The template may also identify websites for nearby woodworking shops and other craftsmen. The small business owner may also provide the application with a website associated with the small business, and the small business outsourcer identifies information from the website and populates the template with information from the website.

In the illustrative embodiment, when the small business receives a customer request for a product or service that the small business would like to outsource, the small business owner notifies the application of the small business's decision to outsource the customer request. The small business owner provides the application with information regarding the service or product to be outsourced, as well as other information such as due date of the service or product, pricing information, and other information.

In one embodiment, the application generates an outsourcing request comprising, e.g., information such as the customer request and business data such as pricing, tools required, or materials required. In such an embodiment, the application generates a list of small businesses capable of fulfilling the outsourcing request and may also match businesses based on ability to fulfill outsourcing requests. In the example of the woodworking shop, the small business owner interacts with a user interface, such as a GUI, associated with the application to generate an outsourcing request. The application identifies small businesses capable of fulfilling the outsourcing request by searching through databases of small businesses that also use the application, websites of similar small businesses in the area, and other databases of information. In the example of the woodworking shop, the application also searches databases associated with a local trade school to identify carpenters to contact as well as websites of local woodworking shops. The application may use agents, such as bots or web crawlers to extract information from social media feeds, such as career networking social media websites which may be used by the application to identify individuals with carpentry experience.

In some embodiments, the application uses machine learning and artificial intelligence to determine whether to recommend a small business as being capable of fulfilling an outsourcing request. In such an embodiment, the small business owner provides information to the application regarding products and services provided by the small business. For example, where the small business is a cleaning service for cleaning inside residences, the application identifies the services provided by the cleaning service such as mopping floors, vacuuming, scrubbing bathtubs, and other services. From the small business owner's description of the services provided to the application by the small business owner as well as the type of business listed by the small business owner, the application identifies other small businesses with similar services or tools to fulfill an outsourcing request. For example, if the outsourcing request is for cleaning services, the application may identify other small businesses that provide mopping services, vacuuming services, and bathroom cleaning services in residences.

In some embodiments, in addition to matching and connecting small businesses, the application also notifies businesses of outsourcing opportunities. For example, when the small business owner submits an outsourcing request, the application may notify small businesses capable of fulfilling the outsourcing request to gauge the small businesses' interest in fulfilling the request. In some embodiments, the small business owner receives a list of potential businesses initially, and selects from the list to determine which businesses to notify.

In some embodiments, the application also may manage terms of outsourcing agreements and negotiations between the business. For example, the application may provide a form contract for the fulfillment of the outsourcing request. The application may also provide a negotiation window on the application's GUI, which allows small businesses to negotiate over fees, payment, and other terms.

In some embodiments, the application also manages division of payment and division of customer feedback between the small businesses. For example, when a product or service has been fulfilled and paid for by the customer, the application may divide payment between the small business that performed the service and the small business that outsourced the service per the terms of the agreement. In such an embodiment, the application may be linked to bank accounts or credit cards associated with the small businesses and may charge and pay accounts of the small businesses. In other embodiments, customers paying for a good or service that has been outsourced pay the application directly, and the money is divided between the small businesses according to the terms of the outsourcing agreement.

In some embodiments, the application divides customer feedback between the small businesses. For example, the small business outsourcer may receive customer reviews and divides the customer feedback between the businesses based on relevance of the feedback to services or products provided by the respective small businesses. For example, in one embodiment a restaurant may send an outsourcing request for a delivery driver to deliver sandwiches. In such an embodiment, the customer receives the sandwiches and leaves a review for the small businesses that the sandwiches tasted great, but the delivery person came late and was rude. In such an embodiment, the small business outsourcer analyzes the customer's review and divides the feedback across the small businesses based on tasks performed by individual small businesses. Thus the small business that made the sandwiches has the positive feedback regarding the sandwich associated with the small business, and the small business delivering the sandwiches has the negative feedback regarding being late and rude.

In some embodiments, the small business outsourcer stores feedback and uses it to determine future recommendations for small businesses to fulfill outsourcing requests. In some embodiments, the more positive the feedback, the more likely the small business outsourcer will recommend outsourcing to a particular small business in the future. Recommendations may include a ranked list of small businesses with scores based on weighted metrics determined by the small business outsourcer and the small business owner. For example, the small business owner may value customer service above other metrics such as location of the small business to fulfill the outsourcing request. The small business outsourcer would rank small businesses with excellent customer feedback regarding customer service higher than other small businesses with similar scores.

### Example Embodiments of a Small Business Outsourcer

One illustrative embodiment of the present disclosure comprises an application executed on a computing system such as a computer, mobile phone, tablet, or other computing device. The small business outsourcer may be executed by the computing system as a native application or may comprise web-based application accessed using a web-browser.

In some embodiments, the small business outsourcer receives input data from users such as small business owners. In such an embodiment, the small business outsourcer may also receive input data from external sources, such as databases, websites, social media feeds, sensors, and other applications associated with a business. The small business may use sensors to assist in determining to send an outsourcing request. For example, a small business owner may have a camera facing the small business's parking lot. The small business owner determines that when the parking lot reaches a certain capacity, the small business owner becomes too busy to fulfill orders placed online. The small business owner may set the small business outsourcer to receive input from the camera that shifts online orders to be outsourced when the parking lot reaches a certain capacity.

In other embodiments, the small business outsourcer may be set to automatically outsource customer requests. For example, the small business owner may choose to automatically outsource work using the small business outsourcer while the small business owner is on vacation. For example, a small business owner may decide to take vacation for a week, and may set new customer requests over the course of the week to be outsourced.

In some embodiments, the small business outsourcer may determine whether small businesses are capable of fulfilling outsourcing requests based on data received by the small business outsourcer and contacts small businesses with outsourcing requests. In such an embodiment, the small business outsourcer may also distribute payments and customer feedback between the small businesses.

In one illustrative embodiment, the small business outsourcer includes a survey, questionnaire, or template configured for use with types of small businesses. For example, a pizza parlor and a mechanic shop may have different templates for small business owners to enter information. The small business owner for a mechanic shop enters business data including the type of business, location of the business, hourly rate of mechanics, tools used by the business, information regarding products and services provided by the small business, and other business data. For example, the small business owner of the mechanic shop specifies what make and models of cars the shop is able to service. The mechanic shop also provides what tools the mechanic shop has and the small business outsourcer makes inferences about what services the small business may provide based on the tools of the small business. For example, the mechanic shop may identify that the shop has a lift. In such an embodiment, the mechanic shop may not advertise that the mechanic shop performs alignments, but based on the tools of the mechanic shop and similar services provided by the small business, the small business outsourcer may draw an inference that the small business may also perform another service to fulfill an outsourcing request.

In some embodiments, the small business owner provides information to the application regarding products and services provided by the small business. For example, where the small business is a residential cleaning service, the small business outsourcer identifies the different services provided by the cleaning service such as mopping floors, vacuuming, scrubbing bathtubs, and other services. From the small business owner's description of the services provided to the application by the small business owner as well as the type of business listed by the small business owner, the application identifies other small businesses with similar services or tools to fulfill an outsourcing request. In the example of the cleaning service, the application identifies other small businesses that provide mopping services, vacuuming services, and bathroom cleaning services in residences. However, not all businesses providing cleaning services provide the same services. For example, small businesses may only service commercial properties, exterior of buildings, or may have other restrictions on services provided. In some embodiments, the small business outsourcer identifies restrictions on services provided by small businesses based on data identified from the small business's website, past fulfilled and denied outsourcing requests, and data from other sources.

In some embodiments, the small business outsourcer may use machine learning and artificial intelligence to determine whether a small business is capable of fulfilling outsourcing requests and whether to recommend a small business to fulfill outsourcing requests. In some embodiments the small business outsourcer uses a Bayesian network, Markov logic network, or other probabilistic logic network to draw inferences and to determine probabilities of outcomes based on variables. The number of variables included in the Bayesian network may be in the thousands, hundreds of thousands, or more. In some embodiments of the small business outsourcer, the small business outsourcer assigns values to characteristics of small businesses and values to characteristics of the outsourcing request including products provided by the small business, services provided by the small businesses, location of the business, feedback from customers regarding past services, and other characteristics of small businesses. In such an embodiment, the small business outsourcer may determine a probability of a small business being capable of fulfilling an outsourcing request and ranks small businesses based on the probability and other factors such as historical data regarding past fulfilled outsourcing requests. For example, when historical data indicates that a small business has fulfilled similar outsourcing requests for the other small business in the past, the small business outsourcer may rank the small business higher than others.

In other embodiments, the small business outsourcer determines whether a small business is capable of fulfilling outsourcing requests and whether to recommend a small business to fulfill outsourcing requests based on reinforcement learning algorithms including but not limited to Q-learning, SARSA, A3N, DQN, A3C, and Bellman. In such an embodiment, the small business outsourcer may incorporate feedback from a small business owner regarding recommendations for small businesses to fulfill an outsourcing request. Business data may be entered as inputs to a machine learning algorithm. In such an embodiment, the small business outsourcer may determine small businesses that may fulfill the outsourcing request and the small business owner may provide feedback to the small business outsourcer, which may be used as additional inputs into the machine learning algorithm to determine future recommendations.

In other embodiments, the small business outsourcer implements learning classifiers which are pre-trained, as well as trained by the small business owner. In such an embodiment, the small business outsourcer may determine rules to define relationships between data based on feedback from the small business owner or other sources. For example, a small business owner may prioritize proximity of a small business fulfilling an outsourcing request over other factors when deciding which small business to outsource work to. In such an embodiment, the small business outsourcer may identify the small business owner's preference for small businesses closer to the small business owner from past outsourcing requests. The small business outsourcer may include the small business owner's preference for closer small businesses in the small business outsourcer's recommendations.

In further embodiments, the small business outsourcer receives information from other small business owners using other small business outsourcers. The small business outsourcer may access databases of business data shared with other small business outsourcers. The small business outsourcer may also access shared databases of feedback from other small business owners to incorporate in future recommendations.

In some embodiments, the small business outsourcer may generate recommendations of small businesses that are determined to be capable of fulfilling an outsourcing request. The recommendation may be a list of one or more businesses, ranked by the small business outsourcer based on weighted metrics set by the small business owner and the small business outsourcer.

For example, the small business owner when filling out the survey, questionnaire, and template, may be asked to rank what metrics are most important to the small business owner. The small business owner may rank preset metrics or may input metrics into an input field. Metrics might include proximity of the small business to the small business owner, hours of operation, number of staff, pricing, and other metrics associated with determining whether to outsource work to a small business.

In some embodiments, weighted metrics are used by the small business outsourcer to determine a score with which to rank small businesses. In some embodiments, the score is a numerical value, such as from 1 to 100, 1 to 10, or other numerical values. The score may also be a letter grade score. In some embodiments, the small business outsourcer uses a binary system, where the small business outsourcer does not rank small businesses, rather determines “yes” or “no” when determining whether a small business is capable of fulfilling an outsourcing request and provides the results to the small business owner.

In some embodiments, the small business outsourcer is configured to allow selection by the small business owner of a small business to contact regarding the outsourcing request from the small business outsourcer recommendations. In such an embodiment, the small business outsourcer transmits a message to the selected small business requesting the selected small business fulfill the outsourcing request. The owner of the selected small business, or other person with authority to make decisions for the selected small business, may accept, deny, or negotiate the outsourcing request using the small business outsourcer. The owner of the selected small business may negotiate over the terms of the agreement prior to agreeing to fulfill an outsourcing request. For example, the owner of the selected small business may submit a request back to the small business owner requesting a higher fee, requesting a percentage of transactions, or negotiating over other terms of the agreement for outsourcing work. The small business owner may accept, deny, or continue to negotiate until an agreement is made. In some embodiments, when an agreement is made, the small business outsourcer maintains a copy of the agreement for future reference by the small business owner and the owner of the selected small business.

In some embodiments, the small business outsourcer contacts small businesses with outsourcing requests to gauge interest before providing the small business owner with a list of small businesses determined to be capable of fulfilling an outsourcing request. The interest provided by the contacted small businesses may be used in ranking the small businesses determined to be capable of fulfilling an outsourcing request.

In some embodiments, the small business outsourcer may also require customer consent to outsourcing a product or service. The customer may have access to the small business outsourcer on the customer's phone, computer, other computing devices, or a browser. The small business outsourcer may contact the customer whose customer request is to be outsourced. The customer may accept, deny, or accept with modification the customer request being outsourced. In such an embodiment, a customer may request that a cleaning company clean the customer's apartment. The customer may ask the cleaning company because the customer knows and trusts the employees of the cleaning company, and the customer does not trust employees of other cleaning companies to enter the customer's apartment. In such an embodiment, the customer may submit a customer request to the cleaning company that forbids the cleaning company from outsourcing the work. In such an embodiment, the customer may forbid outsourcing of particular services and products, may forbid particular small businesses from fulfilling an outsourcing request for the customer, and may forbid the outsourcing of all customer requests associated with the customer.

In some embodiments, the small business outsourcer requires customer authorization to outsource a customer request. The customer authorization may include the customer providing consent to the outsourcing through the small business outsourcer running on a small business's computing device, or by consenting through an SMS, email, or phone call to the customer.

In other embodiments, the small business outsourcer may also be used to manage financial transactions between the small businesses and the customer. In such an embodiment, the customer may pay the small business outsourcer directly and the small business outsourcer may divide payment per the terms of the agreement made by the small business making the outsourcing request and the small business fulfilling the outsourcing request. In such an embodiment, the small businesses may provide banking information to the small business outsourcer and the small business outsourcer may send payment to the small business's bank account.

In some embodiments, the small business outsourcer also tracks that the outsourcing request has been fulfilled. In such an embodiment, the small business outsourcer may require that a business submit proof of fulfillment such as a picture. In some embodiments, proof of fulfillment may include the customer signing off on fulfillment. In other embodiments, the customer may receive a QR code through the small business outsourcer, or through email or an SMS. In some embodiments, the small business outsourcer may use a camera associated with personal device such as a phone to scan the QR code to confirm fulfillment of the outsourcing request.

In further embodiments, the small business outsourcer receives feedback from customers and may allocate feedback between the small businesses outsourcing the work and the small business fulfilling the outsourcing request. For example, where the outsourcing request is for a plumber, the customer may provide feedback that the service was excellent, but the prices were too expensive. In such an embodiment, the small business setting the prices may receive the feedback regarding the pricing, and the small business performing the service may receive the feedback regarding the service. Feedback from customers may be used by the small business outsourcer in future recommendations for small businesses to outsource work.

### Illustrative Methods of Operation of a Small Business Outsourcer

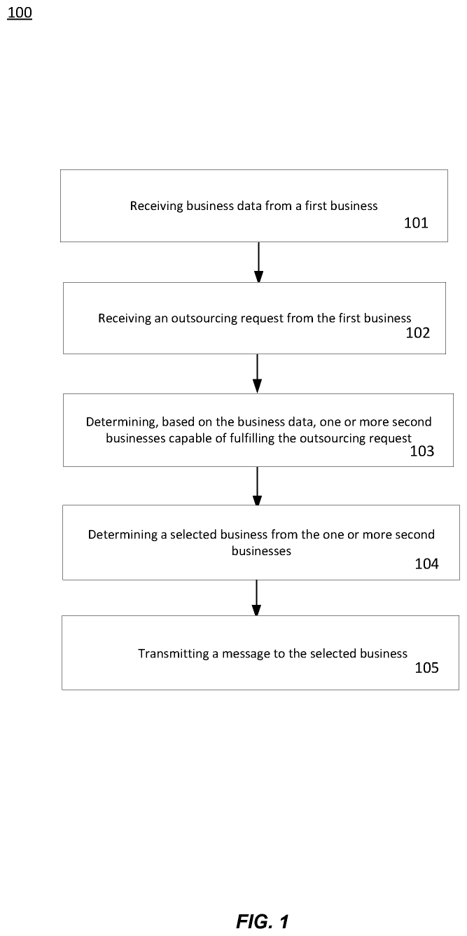

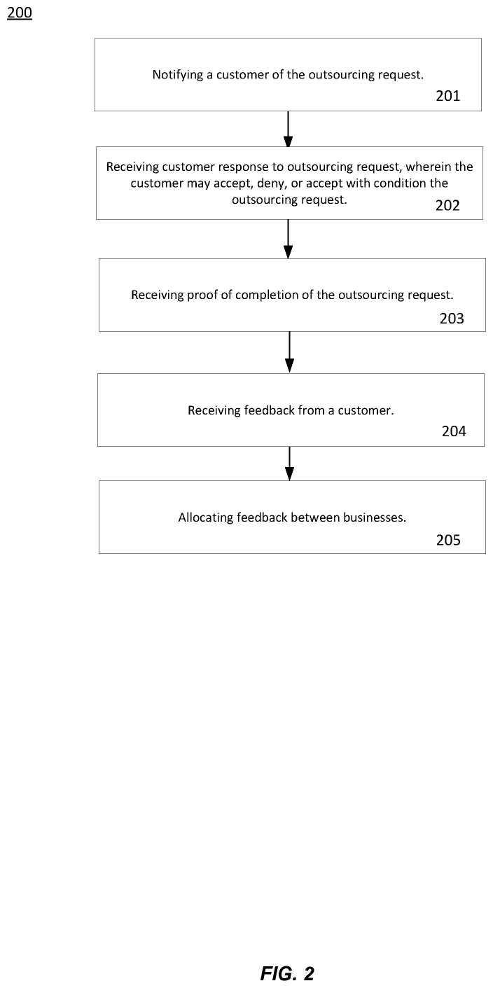

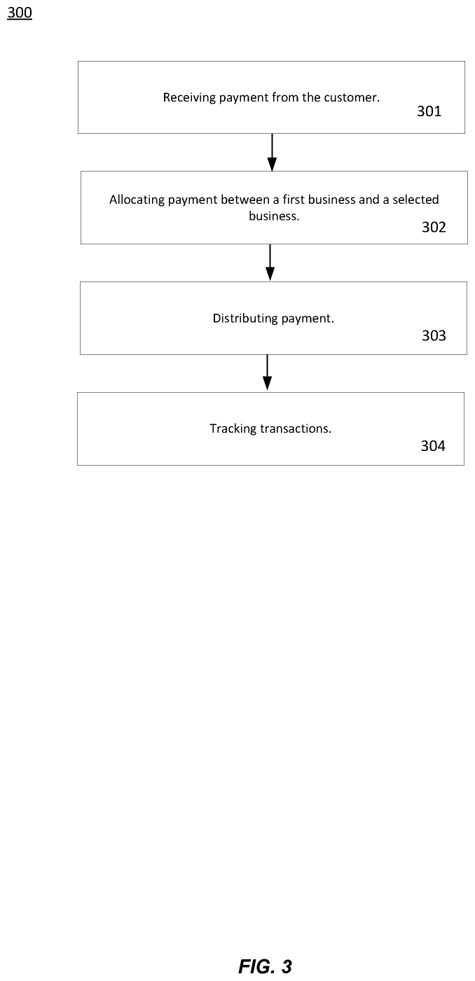

FIG. 1, FIG. 2, and FIG. 3 are flowcharts showing illustrative methods 100 200 and 300 for operation of a small business outsourcer. In some embodiments, some of the steps in flow charts of FIGS. 1, 2, and 3 are implemented in program code executed by a processor, for example, the processor in a general purpose computer, mobile device, or server. In some embodiments, these steps are implemented by a group of processors. In some embodiments the steps shown in FIGS. 1, 2, and 3 are performed in a different order or one or more steps may be skipped. Alternatively, in some embodiments, additional steps not shown in FIGS. 1, 2, and 3 may be performed.

The method 100, shown in FIG. 1, begins with step 101 with the small business outsourcer receiving business data from a first business. The small business owner or other user enters data into the small business outsourcer associated with the business, such as the type of business, location of the business, pricing information, products, services, and other data. The small business owner may enter data associated with the business through a questionnaire, template, or by inputting a description of the business. The small business outsourcer also receives information from applications used by the business, such as accounting, banking, and finance applications, as well as from the business's website. For example, the small business owner may connect the small business outsourcer to accounting software used by the business, which provides data to the small business outsourcer indicating prices of sold products and services. The small business outsourcer may also monitor websites, databases, sensors, social media feeds, and other sources to collect data associated with the first business.

Step 102 includes receiving an outsourcing request from the first business. The small business owner inputs an outsourcing request into the small business outsourcer when the small business owner receives a customer request that the small business owner is unable to fulfill, but still would like to receive the customer's business. For example, the small business owner of a pizza parlor inputs an outsourcing request into the small business outsourcer to find an available food delivery person to deliver pizzas when the pizza parlor is short-staffed. The small business owner may input outsourcing requests through a personal device, such as a phone, computer, and other computing device capable of accessing the small business outsourcer.

The method 100 continues with step 103 which includes determining, based on the business data, one or more second businesses capable of fulfilling the outsourcing request. The small business outsourcer categorizes or classifies the data related to the outsourcing request and the small business making the outsourcing request into categories based on a number of characteristics of the data including but not limited to: type of business, location of the business, location the outsourcing request is to be fulfilled, pricing of products and services, tools needed to fulfill the outsourcing request, history of outsourcing request fulfillment, customer ratings of businesses, filters set by customers and businesses, and other characteristics of the data. For example, a small business may determine not to work with a particular business. The small business may set a filter, so that the particular business is not recommended to the small business, even where the particular business is determined to be more likely to be capable of fulfilling an outsourcing request than other businesses.

In an example of a residential cleaning business, the small business owner may receive a customer request to clean the customer's home, but due to higher than expected workflow, the small business owner may lack enough staff to fulfill the customer's request. The small business owner, not wanting to lose business, inputs an outsourcing request to the small business outsourcer. The small business owner includes data associated with the customer request in the outsourcing request to identify what services the customer wants to receive.

For example, a customer seeking his or her house to be cleaned may request the cleaning service vacuum, mop, and scrub his or her shower. In some embodiments, the small business outsourcer may identify the services requested and may identify businesses capable of fulfilling the outsourcing request. The small business outsourcer may also identify the location of where the outsourcing request is to be fulfilled, in this example, the customer's house. The small business outsourcer may further determine the type of business to fulfill the request and may identify businesses of that type within a predetermined distance or commute time of the location of where the outsourcing request is to be fulfilled. In such an embodiment, the predetermined distance may be set by the outsourcing business, the potential business to fulfill the outsourcing request, the small business outsourcer, or the customer.

The small business outsourcer determines whether the identified businesses are capable of fulfilling the outsourcing request. In the example of the outsourcing request for cleaning a customer's house, the small business outsourcer identifies multiple cleaning services within a predetermined distance from the location the outsourcing request is to be fulfilled. However, the small business outsourcer may determine from some of the identified cleaning services websites, that the cleaning services only service commercial buildings, and therefore would be unwilling to fulfill an outsourcing request to clean a residence. In some embodiments, the small business outsourcer may generate a list of businesses that may fulfill the outsourcing request and would not include results for small businesses only offering commercial cleaning services.

The method continues to step 104, where the small business owner determines a selected business from the one or more second businesses determined by the small business outsourcer to be capable of fulfilling the outsourcing request. In some embodiments the small business owner chooses a small business from a ranked list of options. In other embodiments, the small business outsourcer pairs the small business with a second small business that the small business outsourcer determines to be a best match for fulfilling the outsourcing request.

The method continues to step 105, where the small business outsourcer contacts the selected business with the outsourcing request. The small business outsourcer may send a message to the selected business via the small business outsourcer application, or to the selected business via a text, phone call, email, or other methods of communication.

The method 200, shown in FIG. 2, illustrates a method of operating the small business outsourcer according to one embodiment.

Method 200 begins with step 201, with the small business outsourcer notifying a customer of an outsourcing request. The customer may receive notification of the outsourcing request through the small business outsourcing application or through SMS, email, a phone call, or other communication technology.

The method continues to step 202, when the small business outsourcer receives a response to the outsourcing request from the customer. In some embodiments, the customer's response may be accepting, denying, or accepting with a condition the outsourcing request. For example, where the customer requested a landscaping service to mow the customer's lawn, water the customer's flowers, and trim the customer's hedges, the customer may allow the outsourcing of some of the work but not others. The customer may decide to allow outsourcing of tasks such as mowing the lawn and watering the flowers, but prefer not to outsource other work such as trimming hedges. In such an embodiment, the customer's response indicates the modification, and the outsourcing request may be amended accordingly.

In step 203, the small business outsourcer receives proof of completion of the outsourcing request. In some embodiments, proof of completion may be a customer submitting payment, customer confirmation that the outsourcing request has been completed, or other proof. In some embodiments, the business fulfilling an outsourcing request may submit a photo of the completed outsourcing request. In other embodiments, the customer receives a QR code, link to a URL, or password through an email or SMS which is used to confirm the outsourcing request was completed. The business fulfilling the outsourcing request may scan the QR code provided to the customer in order to confirm the outsourcing request was fulfilled.

In step 204, the customer sends feedback to the small business outsourcer. The customer may leave feedback such as that customer service was great and the prices were excellent. The customer may also submit a survey regarding the customer's experience.

In step 205, the small business outsourcer allocates feedback between the businesses. In some embodiments, feedback associated with a first business is allocated to the first business and feedback associated with a second business is allocated to the second business. In the example of the customer receiving landscaping services, the business setting the prices may receive the feedback regarding prices, and the business providing the customer service may receive the feedback regarding customer service.

Method 300, shown in FIG. 3, illustrates the small business outsourcer's management of payment distribution for outsourcing requests between an outsourcing business and a business fulfilling an outsourcing request according to one embodiment.

Method 300 begins with step 301, receiving payment from a customer. In some embodiments, the customer may provide payment for products and services through the small business outsourcer. In some embodiments, the customer pays either the outsourcing business or the business fulfilling the outsourcing request. The outsourcing business or the business fulfilling the outsourcing request may agree to hold an amount of money the value of the price of fulfilling the outsourcing request in escrow through the small business outsourcer until the customer has paid for the product or service.

In step 302, the small business outsourcer allocates payment between a first business and a selected business. In one embodiment, the small business outsourcer may allocate payment between the first business and the selected business based on the terms of the agreement to which both businesses previously agreed. For example, the first business and the selected business may have agreed that the first business receive a finder's fee for 10% of the customer's payment. In such an embodiment, the small business outsourcer allocates the customer's payment 10% to the first business and 90% to the selected business.

In step 303, the small business outsourcer distributes payment to the first business and the selected business. In some embodiments, the small business outsourcer may be linked to bank accounts associated with the first business and the selected business. The small business outsourcer may transmit payment to the bank accounts associated with the respective business.

In step 304, the small business outsourcer tracks transactions. In some embodiments, the small business outsourcer may use past successful transactions in determining whether to recommend a small business for fulfilling an outsourcing request. In such an embodiment, small businesses with more successful transactions through the small business outsourcer may be determined by the small business outsourcer to be more likely to fulfill an outsourcing request.

### A Small Business Outsourcer System

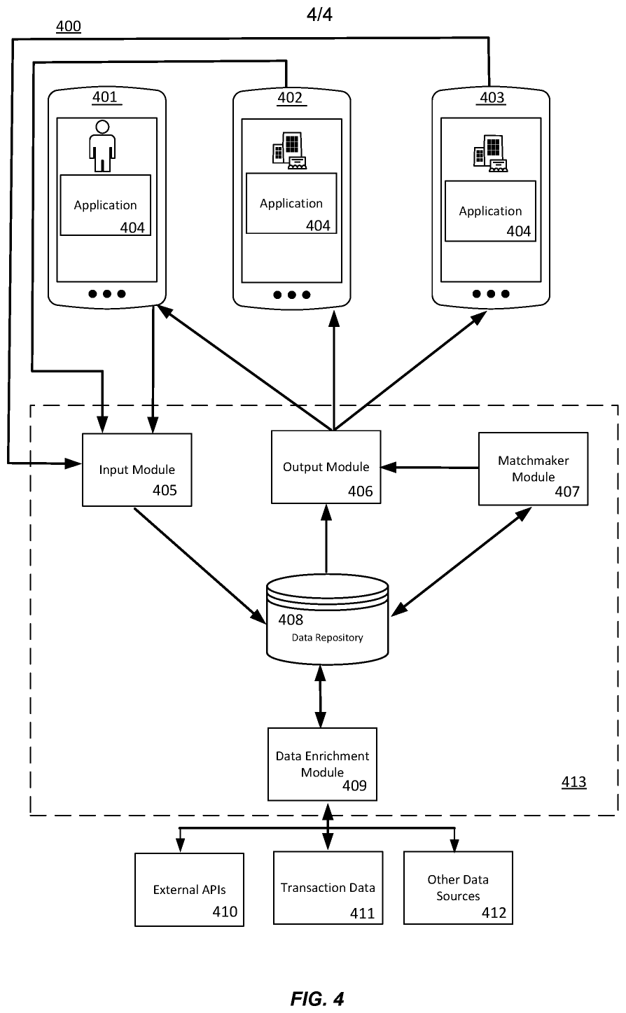

FIG. 4 shows an illustrative small business outsourcer system 400 according to one embodiment. In such an embodiment, the small business outsourcer system includes customer device 401, small business devices 402 403, small business outsourcer application 404. The small business outsourcer system 400 also includes input module 405, output module 406, matchmaker module 407, data repository 408, and data enrichment module 409 which runs on server infrastructure 413. Further, the small business outsourcer system 400 also includes external APIs 410, transaction data 411, and other data sources 412.

In FIG. 4, the small business outsourcer system 400 is configured to receive inputs from customer device 401 and small business devices 402 403 through application 404. Application 404 may be run locally on the customer device 401 operated by one or more customers (not shown) and small business devices 402 403 operated by small business owners or other individuals with authority to act on behalf of a small business (not shown). Customer device 401 and small business devices 402 403 may include phones, laptops, tablets, and other computing devices. In alternative embodiments, application 404 may be accessible by the customer device 401 and small business devices 402 403 through a browser.

The one or more customers and the small business owners interact with application 404 through a graphical user interface (GUI) that is accessible through application 404 on the computing device or through a web browser. The GUI may include tabs indicating information such as list of data sources, tabs indicating input business data, tabs indicating past transactions, tabs indicating outstanding outsourcing requests and customer requests, tabs indicating recommendations for outsourcing, and tabs indicating other information. In some embodiments, the GUI is also configurable by a user, allowing the user to rearrange tabs and other objects, as well as to adjust settings. In other embodiments, the GUI also includes input fields allowing users to input information or search for information in a search bar. For example, a small business owner may identify a business to which the small business owner would like to send an outsourcing request. The small business owner may search the business in a search bar of the application 404 and message the business through the application 404.

The GUI also uses Natural Language processing in the search bar and input fields, a notifications icon, drop down menus, and other menus.

The small business devices 402 403 provide inputs which may include business data to application 404. Business data includes the type of business, location of the business, wages of workers, tools used by the business, information regarding products and services provided by the small business, and other business data. Application 404 may prompt small business devices 402 403 for additional business data through surveys, questionnaires, and templates.

The application running on customer device 401 and small business devices 402 403 may communicate to server infrastructure 413 through a communication network (not shown) such as the internet. In such an embodiment, the application 404 sends information to server infrastructure 405 through an input module and receives output from the server infrastructure 413 through an output module 406. In alternative embodiments, the input module 405 and output module may be combined into a module that may both input and output information.

In some embodiments, the server infrastructure 413 may supports operation of the input module 405, output module 406, matchmaker module 407, data repository 408, and data enrichment module 409. In such an embodiment, inputs received by the input module 405 from customer device 401 and small business devices 402 403 are stored in data repository 408. The data repository 408 may store business data input from small business devices 402 403 and feedback data from customer device 401. Application 404 may also request information from the data repository 408. For example, a small business owner may navigate the GUI of application 404 and click on a tab requesting to view past business data input by the small business owner. The small business owner's request from the click on the tab to view past business data may be received by server infrastructure 413 through input module 405. The input module 405 transmits the request to the data repository 408 which transmits the business data to the output module 406. Application 404 receives the business data and displays the business data on the small business device 402 403 through the GUI.

Data repository 408 also communicates with matchmaker module 407. Matchmaker module 407 determines small businesses capable of fulfilling outsourcing requests. For example, the small business owner operating small business device 402 determines to submit an outsourcing request. The small business owner submits the outsourcing request through the GUI on application 404 on small business device 402. Small business device 402 communicates to the input module 405 through a communication network (not shown) such as the internet. The input module transmits the outsourcing request to the data repository 408 where the request is logged, and the data repository 408 transmits the outsourcing request to matchmaker module 407. Matchmaker module 407 analyzes the outsourcing request and pulls business data from data repository 408.

The matchmaker module 407 may identify characteristics of the outsourcing request and the business data and uses artificial intelligence and machine learning to determine whether a small business is capable of fulfilling an outsourcing request. In some embodiments, the matchmaker module 407 may use Bayesian network, Markov logic network, or other probabilistic logic network to draw inferences regarding characteristics of the outsourcing request and the business data to determine probabilities of the small business being capable of fulfilling the outsourcing request based on variables representing the characteristics.

In some embodiments, the matchmaker module 407 generates a score based on inferences drawn and determines a ranked list of small businesses capable of fulfilling the outsourcing request. In further embodiments, the matchmaker module 407 determines a best match, and the best match is displayed through the GUI on application 404. The best match may be the small business determined by the matchmaker module 407 to have the highest probability of being capable to fulfill the outsourcing request. The matchmaker module 407 may transmit the determined small business to the output module 406 which transmits the matchmaker module's 407 determination to the small business device 402. The determination is displayed to the small business owner through the GUI of the application 404 running on the small business device 402.

The data repository 408 is also connected to data enrichment module 409. In some embodiments, the data enrichment module 409 uses agents, such as bots or web crawlers, to extract information and data from searches for more data sources and may be used to identify additional data and data sources to be used in future determinations made by the matchmaker module 407. In some embodiments, the data enrichment module 409 may communicate to data sources external to the server infrastructure 413, and identify data to be used in future determinations made by the matchmaker module 407. For example, the data enrichment module may search external APIs 410. The external APIs 410 may be associated with a cloud service or other applications that may include business data or other data associated with a business that may be capable of fulfilling an outsourcing request. For example, the data enrichment module 409 may send and receive information to external APIs 410 related to an accounting service used by a small business. The data enrichment module 409 may receive data related to pricing and sales related to the small business from the accounting service. The pricing and sales data may then be transmitted to the data repository, where the data is stored, and then transmitted to the matchmaker module 407 where the data is used in future determinations.

The data enrichment module 409 is also connected to other data sources 412 such as databases, as well as data sources including transaction data 411. Transaction data 411 includes data related to bank accounts of small businesses. For example, the data enrichment module 409 may request information regarding balances and lines of credit. In some embodiments, the matchmaker module 407 may use the transaction data 411 to determine whether a small business has the financial means to fulfill an outsourcing request, and may use the transaction data 411 to draw other inferences related to determining whether a small business is capable of fulfilling an outsourcing request.

Other data sources 412 may include databases. For example, the data enrichment module 409 may identify a database from of a vocational college including information related to graduates who completed an apprenticeship for becoming a plumber. Where an outsourcing request includes a customer request for plumbing, the data enrichment module 409 may search the database for nearby plumbers, and may transmit the data to the data repository 408.

### Example Advantages of a Small Business Outsourcer

The small business outsourcer is useful for small businesses in managing variable workflows. For example, a small business may not realize that a nearby event will lead to an influx of customers. When the small business receives an unexpected influx of customers, the small business may have to make tough decisions such as whether to turn away business or to take on too much business which may lead to a decrease in quality of the business's products and services. The small business outsourcer determines whether other small businesses are capable of taking on outsourced work from the small business, which allows the small business to accept more business than the small business would otherwise be able to accept.

In another example, a customer may request additional services that the small business is unable to perform, which the small business would prefer to outsource so that the small business does not lose the customer. For example, a customer may request a blue table from a carpentry business. If the carpentry business is able to construct the table, but unable to paint the table the color the customer requests, the carpentry business may outsource painting the table to another small business allowing the carpentry business to fulfill the customer's request.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first business and a second business generally correspond to business 1 and business 2 or two different businesses. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

1. A method comprising:
receiving business data from a first business and business data from a pool of one or more additional businesses;
receiving an outsourcing request from the first business;
determining, based on the business data from the first business and from the pool of one or more additional businesses, one or more additional businesses capable of fulfilling the outsourcing request;
determining by a matchmaker module a selected business from the one or more additional businesses by:
creating a recommendation dataset from the business data from one or more of the first business, the business data from the pool of one or more additional businesses, and the outsourcing request from the first business;
pretraining a neural network using the recommendation dataset and selecting a pretrained recommendation by inputting an outsourcing request into the neural network;
transmitting the pretrained recommendation to a customer and receiving a customer response wherein the customer response is one of: accepting the outsourcing request, rejecting the outsourcing request, or accepting the outsourcing request with a condition;
retraining the neural network using the customer response and determining the selected business by inputting the outsourcing request into the retrained neural network;
transmitting a message to the selected business;
receiving generalized feedback from the customer;
dividing the generalized feedback into first business specific feedback and selected business feedback; and
allocating the first business specific feedback to the business data of the first business and the selected business feedback to business data of the selected business.

2. (canceled)

3. (canceled)

4. The method of claim 1, wherein the condition is that the outsourcing request be completed by another business.

5. The method of claim 1, further comprising:
Receiving payment from the customer;
allocating payment between the first business and the selected business; and
distributing payment.

6. The method of claim 1, further comprising displaying on a user interface a list of the one or more additional businesses and wherein determining the selected business comprises receiving user input from a user associated with the first business.

7. The method of claim 1, wherein determining the one or more additional businesses capable of fulfilling the outsourcing request is further based on past outsourcing requests between the first business and the one or more additional businesses and feedback by the first business.

8. The method of claim 7, wherein the feedback by the first business triggers filters to prevent specific businesses from being recommended to fulfill outsourcing requests by the first business.

9. The method of claim 1, wherein the business data comprises one or more of a description of the first business, services provided by the first business, products provided by the first business, pricing of products and services, location of the first business, and tools used by the first business.

10. The method of claim 1, further comprising:
Receiving proof of completion of the outsourcing request, wherein proof of completion comprises one or more of: a picture of the completed outsourcing request, customer confirmation of the completed outsourcing request, receiving proof of payment by the customer, and customer scan of a QR code.

11. A non-transitory computer readable medium comprising instructions that when executed by one or more processors cause the one or more processors to:
receive business data from a first business and business data from a pool of one or more additional businesses;
receive an outsourcing request from the first business;
determine, based on the business data from the first business and from the pool of one or more additional businesses, one or more additional businesses capable of fulfilling the outsourcing request;
determine businesses capable of fulfilling the outsourcing request based on the business data and matching criteria;
determine, by a matchmaker module, a selected business from the one or more additional businesses by:
creating a recommendation dataset from the business data from one or more of the first business, the business data from the pool of one or more additional businesses, and the outsourcing request from the first business;
pretraining a neural network using the recommendation dataset and selecting a pretrained recommendation by inputting an outsourcing request into the neural network;
transmitting the pretrained recommendation to a customer and receiving a customer response wherein the customer response is one of: accepting the outsourcing request, rejecting the outsourcing request, or accepting the outsourcing request with a condition;
retraining the neural network using the received customer response and determining the selected business by inputting the outsourcing request into the retrained neural network;
transmits a message to the selected business;
receive generalized feedback from the customer;
divide the generalized feedback into first business specific feedback and selected business feedback; and
allocate the first business specific feedback to the business data of the first business and the selected business feedback to business data of the selected business.

12. (canceled)

13. (canceled)

14. The non-transitory computer readable medium of claim 11, wherein the condition is that the outsourcing request be completed by another business.

15. The non-transitory computer readable medium of claim 11, further comprising instructions that when executed by the one or more processors cause the one or more processors to:
receive payment from the customer;
allocate payment between the first business and the selected business; and
distribute payment.

16. The non-transitory computer readable medium of claim 11, further comprising instructions that when executed by the one or more processors cause the one or more processors to display on a user interface a list of the one or more additional businesses and wherein determining the selected business comprises receiving user input from a user associated with the first business.

17. The non-transitory computer readable medium of claim 11, wherein determining the one or more additional businesses capable of fulfilling the outsourcing request is further based on past outsourcing requests between the first business and the one or more additional businesses and feedback by the first business.

18. The non-transitory computer readable medium of claim 17, wherein the feedback triggers filters to prevent specific businesses from being recommended to fulfill outsourcing requests by the first business.

19. The non-transitory computer readable medium of claim 11, further comprising instructions that when executed by the one or more processors cause the one or more processors to receive proof of completion of the outsourcing request, wherein proof of completion comprises one or more of: a picture of the completed outsourcing request, customer confirmation of the completed outsourcing request, receiving proof of payment by the customer, and customer scan of a QR code.

20. A system comprising:
one or more processors configured to:
receive business data;
receive an outsourcing request;
generate, based on the business data, matching criteria to match businesses with outsourcing requests;
determine businesses capable of fulfilling the outsourcing request based on the business data and matching criteria;
generate a list of businesses capable of fulfilling the outsourcing request;
receive a business selection from a matchmaking module configured to:
create a recommendation dataset from the business data and the outsourcing request;
pretrain a neural network using the recommendation dataset and select a pretrained recommendation by inputting an outsourcing request into the neural network;
transmit the pretrained recommendation to a customer and receive a customer response wherein the customer response is one of: accepting the outsourcing request, rejecting the outsourcing request, or accepting the outsourcing request with a condition;
retrain the neural network using the customer response and determine the selected business by inputting the outsourcing request into the retrained neural network;
notify the selected business;
receive generalized feedback from the customer;
divide the generalized feedback into first business specific feedback and selected business feedback; and
allocate the first business specific feedback to the business data of the first business and the selected business feedback to business data of the selected business.
